(19) United States
(12) Patent Application Publication
(10) Pub. No.: US 2022/0015350 A1
(43) Pub. Date: Jan. 20, 2022

(54) INSECT REPELLENT TORCH CONVERSION KIT ENABLING AUTOMATIC FUEL REPLENISHMENT

(71) Applicant: Joseph Pannullo, Essex Fells, NJ (US)

(72) Inventor: Joseph Pannullo, Essex Fells, NJ (US)

(21) Appl. No.: 17/023,957

(22) Filed: Sep. 17, 2020

Related U.S. Application Data
(63) Continuation-in-part of application No. 16/928,767, filed on Jul. 14, 2020, now Pat. No. 10,842,146.

(51) Int. Cl. A01M 29/12; F23D 3/28; F23K 5/14; F23D 3/30

(52) U.S. Cl. CPC A01M 29/12; F23D 3/28; F23D 2202/00; F23D 3/30; F23K 5/14

(57) ABSTRACT

A kit for converting an insect repelling torch to enable remote refueling while in operation includes a fuel insert sealed at opposite ends to a fuel pipe and to a wick. This fuel insert is installed within the torch with the wick extending upward into the combustion area, and the fuel pipe extending below the torch. The fuel pipe is connected to the automatic refueling system. In embodiments, the fuel insert can be compressed for insertion through a port into the torch and re-expansion within the torch. Or the fuel insert can be rigid, and can replace a removable fuel canister of the torch. Embodiments can convert previously manufactured torches, and/or can be implemented in the manufacture of new torches otherwise based on conventional designs. Embodiments include fuel level sensors, flame ignitors, fuel valves, local controllers, wireless communication with a remote computing device, batteries, and/or solar cells.

### RELATED APPLICATIONS

This application is related to U.S. application Ser. No. 16/928,767, filed Jul. 14, 2020, which is herein incorporated by reference in its entirety for all purposes.

### FIELD OF THE INVENTION

The invention relates to apparatus for controlling and repelling insect pests, and more particularly, to torches that repel insects by burning a fuel that contains an insect repellent substance.

### BACKGROUND OF THE INVENTION

The enjoyment of outdoor activities during periods of warm weather is highly popular, but is often hindered by the prevalence of insect pests, which can include swarming insects such as gnats, as well as biting insects such as black flies and mosquitos. Furthermore, mosquitos are the greatest menace for spreading diseases like dengue, malaria, yellow fever, zika, west nile, and many others, causing millions of deaths each year. More than 35% of the world population lives in an area where the risk of diseases such as dengue is high.

According to the recent statistics of the United States CDC (Center for Disease Control and Prevention) published in the year 2019, the incidence of dengue, has risen by 30 times in the past 30 years, worldwide. The report also states that the parasite disease called limphatic filaraisis that is transmitted by repeated mosquito bites over a period of a few months affects more than 120 million people in approximately 72 different countries.

The COVID-19 pandemic, caused by the SARS-CoV-2 virus, has given rise to social distancing restrictions and individual safety preferences that have led to even greater usage of outdoor areas, both for private gatherings and for many commercial activities. For example, outdoor restaurant dining has greatly increased during the pandemic, and other businesses, including many hair salons, have been required to shift their services outdoors.

The hospitality and food service industries have been especially vulnerable to the pandemic, which has led to economic hardships for businesses and employees, and loss of significant state tax revenues. The survival of many of these restaurants and other food service companies depends heavily on the success of outdoor dining.

While it is generally assumed that the COVID-19 pandemic will not continue indefinitely, nevertheless the emergence of SARS-CoV-2 has greatly heightened public awareness of the risks that are associated with highly transmissible infectious diseases, and of the possibility that another, more virulent strain could one day appear in the future. As a result, some of the changes in social behavior that have resulted from the pandemic, such as distancing and shifting activities such as dining to outdoor areas, are likely to persist well after the present pandemic is defeated.

Global warming is also increasing the problem of insect pests in outdoor areas, because higher temperatures provide optimum conditions for mosquitoes to breed, and increases their level of activeness.

Accordingly, there is a pressing need to expand ways to provide outdoor spaces for patrons and workers with minimal risk of hinderance by insect pests.

One approach to avoiding bites by insects is to apply an insect repellent directly to the skin. However, this approach is sometimes undesirable, because of the residue that remains on the skin after the outdoor activity has concluded, as well as a reluctance to spend time applying the repellent and subsequently washing the repellent off again.

Furthermore, repellents applied to the skin may fail to provide adequate protection from insects, for example if there is an inadvertent failure to apply the repellent to certain skin regions. Furthermore, some insects, such as mosquitos, are frequently able to bite a victim through clothing, on the scalp through hair, or at a location where the hair is parted and the underlying scalp is exposed.

Many outdoor activities, such as barbecues and outdoor restaurant services, take place in relatively limited areas, such as on a deck or patio, or in a limited region that has been set aside specifically for such activities. One approach in such cases is to spray the area with an insecticide or repellent before the activity begins. Systems exist that provide permanently installed insecticide misting jets fed from a central tank of insecticide, intended for periodic, automated misting of an outdoor area with insecticide. However, insecticides are toxic and noxious, and are therefore limited to application when an outdoor area is not in use.

Furthermore, the use of pesticide spray is inappropriate in an open table dining environment, in part because insecticides can leave a toxic residue on tables, chairs, and other surfaces. In addition, pesticides are mainly effective at the time of application, because they lose most of their ability to kill pests as they disburse and dry. To the extent that pesticides may have any long-term effectiveness, that benefit is lost if the pesticide residue is washed away by rain or by lawn irrigation. For that reason, some pesticide systems include an option for a user to invoke spray on-demand for increased effectiveness during high pest periods, and/or to re-apply the pesticide after rainfall or lawn irrigation. In addition, the application of pesticides in large quantities can be harmful to the environment.

Another approach is to surround an activity area with devices that attract and electrocute insects, in the hope that any approaching insects will be lured away and destroyed before they reach the outdoor activity area. However, this approach can backfire, in that the luring features of these devices can draw additional insects to the activity area, such that even though some insects are intercepted, a large number of others continue past the devices and enter the activity area.

With reference to FIG. 1A, another, somewhat more effective method for repelling insects from an outdoor activity area 100 is to surround the area 100 with torches 102 that burn a fuel that is mixed with a natural and non-toxic insect repellent such as citronella. Often, the torches are supported on poles 106 that are simply inserted into the ground. Ironically, this approach can be least effective where it is most needed, which is in wet climates, because the ground can become too soft and water-saturated to support the torches, especially when rain is accompanied or followed by wind. As an alternative, the torches 102 can be permanently mounted, for example set into a cement slab, removably insertable into holes provided in an underlying hard surface, or supported by removable stands 104, which can be filled with sand or water to increase weight and stability.

As the fuel is burned in the torches 102, the repellent is continuously vaporized and disbursed throughout the activity area 100, thereby continuing to repel insects away from the area 100 for as long as the torches 102 continue to burn. Furthermore, if an activity takes place, or continues, after sunset, the light from the torches 102 can be an esthetically attractive feature. For these reasons, so-called “Tiki” torches 102 are very frequently used to repel mosquitos, fireflies, insects, and other pests. In particular, “tiki” torches 102 are highly preferred for repelling mosquitos.

With reference to FIGS. 1B and 1C, conventional insect repelling torches 102 generally include a local fuel tank 108. In the example of FIG. 1B the fuel tank 108 is the entire interior of the torch 102, while the torch of FIG. 1C includes a separate fuel tank 108 within an outer shell 120. The torches 102 in FIGS. 1B and 1C further include a wick port 110 through which a wick 112 is inserted into fuel 116 contained within the fuel tank 108. The fuel tank 108 is filled with fuel 116 by pouring fuel 116 manually into the fuel tank 108 before the wick 112 is ignited. The torch of FIG. 1B includes a separate fuel port 114 for filling of the fuel tank, while the torch 102 of FIG. 1C is filled by temporarily removing the wick 112 and filling the tank 108 through the wick port 110. The torch 102 in FIG. 1B further includes a cylindrical cavity 118 into which a pole 106 can be inserted for support of the torch 102 above the ground, while the torch 102 of FIG. 1C is permanently welded to the top of the pole 106.

While effective, conventional insect repelling torches 102 typically have small fuel tanks 108, which can become exhausted before an outdoor activity has ended. While the fuel tanks 108 in such torches 102 can typically be refilled, most cannot be safely refilled while in use, nor can they be safely refilled after use until they have cooled to a temperature that is near ambient.

Recently, a system has been introduced by the present Applicant that maintains a significant quantity of insect-repellent fuel in a central reservoir, from which one or more insect repelling torches are automatically refilled as needed, without requiring that the torches be extinguished. This approach requires that some sort of plumbing be provided to deliver the fuel from the central reservoir to each torch, for example through hollow poles that support the torches, and that the torches themselves include internal plumbing in liquid communication with the reservoir of the torch. Some versions of this approach further include fuel level sensors, fuel valves, microprocessors, batteries, solar panels, wick sealers, flame ignitors, local controllers, and/or other features. This approach can provide a viable, eco-friendly solution that can enable outdoor private and commercial activities during a global pandemic and beyond.

One drawback to this approach, however, is that the torches must be specifically designed to support automatic refueling from the central reservoir. Accordingly, because these torches are produced in more limited quantities as compared to conventional insect repellent torches, they tend to have higher production costs and to be available only in a limited variety of designs.

What is needed, therefore, is an apparatus and method for reducing production costs and increasing the range of styles that are available for insect repellent torches that are compatible with refueling from a central reservoir while they continue to burn fuel.

### SUMMARY OF THE INVENTION

The present invention is an apparatus and method for reducing production costs and increasing the range of styles that are available for insect repellent torches that are compatible with refueling from a central reservoir while they continue to burn fuel.

Specifically, the present invention is a conversion kit and method of use thereof that is applicable to a wide array of existing designs of insect repellent torches, either to convert a previously manufactured, conventional torch into a remotely refuellable torch as a retrofit, and/or for implementation by a manufacturer of conventional insect repellent torches so as to manufacture remotely refuellable torches with minimal changes to an existing parts inventory and existing manufacturing process, thereby maintaining an economy of scale for parts and assembly steps that are common to both the conventional and refuellable torches, and consequently reducing the costs of manufacturing the remotely refuellable torches and distributing them to retailers and/or end users by taking advantage of existing open or proprietary designs, production facilities, and supply chain logistics. In addition, environmental impact can be reduced, economic efficiency can be increased, and improved access to providers and users can be realized.

Accordingly, the ability provided by the present invention to modify existing insect repellent torch production regimes and designs has a net positive impact on the environment and a potential to accelerate eco-friendly deployment, while mitigating health risks of mosquito borne disease spread and improving social distancing, promoting economic activity, and limiting pesticide use by providing a more eco-friendly option.

In addition, converting existing insect repellent torches according to the present invention can eliminate a need for the existing torches to be discarded or recycled, thereby avoiding the addition of durable waste to the environment. Furthermore, implementation of the remotely fueled insect repellent torches need not be subject to transcontinental or global supply chains, in that existing supply chains need not add new transport legs. Instead, it is only necessary to produce or source the conversion kit of the present invention, which is relatively small, light, and easy to manufacture locally and in small quantities. The present invention can thereby reduce carbon emissions that might result from a need to increase trans-continental or global transport of remotely refueled torches by leveraging the current annual production of millions of torches.

The disclosed conversion kit includes a fuel insert that is configured to contain a fuel for use in an insect repellent torch. The fuel insert is sealed or sealable at its proximal end to a fuel delivery pipe, and at its distal end to a torch wick. In embodiments, the fuel insert is compressible and expandable, so that it can be inserted into a sealed torch through a relatively small opening. In other embodiments, the fuel insert is rigid, and is either included in the torch during manufacture or replaces an existing, separate fuel tank that is removable from the torch.

Embodiments of the present method include creating or providing an insertion port that provides external access into the fuel tank of a conventional insect repellent torch, in embodiments at the bottom of the fuel tank, and inserting a “fuel insert assembly,” i.e. an assembled wick, fuel insert, and fuel delivery pipe, through the insertion port, so that the wick extends upward beyond the fuel tank and through an upper wick opening provided in the torch, while the fuel delivery pipe extends from the bladder out through the insertion port.

In embodiments, the fuel insert assembly is then fixed to the torch, for example by a fitting that can be threaded or otherwise attached to the insertion port and clamped to the fuel delivery pipe. In embodiments, it is not necessary that the insertion port be sealed, because the torch fuel is fully contained by the fuel insert. On the other hand, in some embodiments it is not necessary that the fuel insert be structurally competent, nor is it necessary for the fuel insert to meet fire safety requirements and/or other regulatory requirements, because these requirements are met by other elements of the torch that surround the fuel insert.

In some embodiments the fuel insert is made from, or includes, a resilient material or structure that can be compressed for insertion through the insertion port, and then naturally returns to an uncompressed state and thereby increases the fuel volume of the fuel insert once it is inside of the torch. In other embodiments, the fuel insert is a bladder that is made of a flexible material, such as a polymer film, and is inflated as it is filled by torch fuel delivered to the fuel insert within the torch via the fuel delivery pipe.

In still other embodiments, the fuel insert is substantially rigid, and in some of these embodiments the fuel insert is either included in the torch during manufacture or installed in the torch in direct replacement for a removable fuel tank that is included in the conventional torch design.

In embodiments, the fuel insert assembly further includes at least one sensor that can be used to determine a quantity of fuel contained within the fuel insert. The at least one sensor can include a fuel level sensor and/or a pressure sensor. For example, if the fuel insert is a bladder that is made from an expandable, elastic material, then measurement of the internal pressure of the fuel within the bladder will be an indication of the degree to which the bladder has been expanded by the fuel, and hence an indication of the quantity of fuel contained within the fuel insert.

In embodiments, the fuel insert assembly includes one or more of the following:
a. a fuel valve configured to allow or prevent entry into the fuel insert of pressurized fuel from the fuel delivery pipe;
b. a wick seal configured to transition between sealing the fuel insert to the wick and allowing the wick to be inserted, withdrawn, or otherwise adjusted within the fuel insert.
c. a wick igniting device;
d. a local controller;
e. one or more batteries; and
f. a solar panel.

Any or all of the fuel valve, wick seal, wick igniting device, and local controller can be remotely operable and controlled via signal communication wires that extend to a remote computing device and/or wirelessly by one or more remote computing devices. In embodiments, at least one feature of the conversion kit is located external to the torch and is not inserted through the insertion port. For example, in embodiments the wick seal, possibly combined with the wick igniting device, is located external to the torch, proximal to the wick as it extends from the top of the torch.

In addition to the advantages noted above, the fuel insert of the present invention improves the isolation of the fuel from rainwater infiltration, which could otherwise render the fuel useless and in need of disposal. Because the fuel insert is located within an exterior structure, and in embodiments within the conventional fuel tank of the torch, exposure of the insect repellent torch to rain will normally result, at most, in the infiltration of rain water into the exterior shell of the torch, but not into the fuel insert where the fuel is located. And even if there is some slight possibility of leakage, either through the fuel insert itself or past the distal or proximal seal of the fuel insert, nevertheless the higher pressure of the fuel within the fuel insert in embodiments will tend to repel the water away from the interior of the fuel insert while maintaining the integrity of the fuel within the fuel insert.

The additional layer of fuel containment that is provided by the fuel insert of the present invention also reduces the likelihood of any leakage or spilling of the fuel. While most insect repelling fuels such as citronella oil mixtures are biodegradable, and spills can be expected to dissipate within 30 days, nevertheless the avoidance of any such spills is desirable.

One general aspect of the present invention is an automatic refueling conversion kit applicable to an insect repellent torch, wherein the insect repellent torch includes a fuel tank configured to contain an insect repellent fuel and a wick port through which a wick can extend from within the fuel tank to a combustion area above the insect repellent torch. The conversion kit includes a fuel insert configured to contain the insect repellent fuel within an interior of the insect repellent torch, a fuel delivery pipe, a fuel delivery seal configured to seal a proximal fuel opening of the fuel insert to a distal end of the fuel delivery pipe, and a wick seal configured to seal a distal wick opening of the fuel insert to a wick. The wick is configured to extend upward and out from the interior of the insect repellent torch through an upper opening provided in the insect repellent torch.

In embodiments, the fuel insert includes a resilient material and/or construction that can be compressed for insertion through an insertion port provided in the insect repellent torch and will afterward re-expand within the interior of the insect repellent torch.

In any of the previous embodiments, the fuel insert can include an elastic material that is configured to expand when the fuel insert is filled with insect repellent fuel. Or the fuel insert can be formed by a substantially rigid material. In some of these embodiments the fuel insert is configured to replace a removable fuel canister of the insect repellent torch.

Any of the previous embodiments can further include a sensor configured to provide a measurement that enables determining of a quantity of the insect repellent fuel that is contained within the fuel insert.

Any of the previous embodiments can further include a remotely controllable wick clamp that is configured to fix a height of the wick in the combustion area when the wick clamp is closed, and to enable adjustment of the height of the wick in the combustion area when the wick clamp is open.

In any of the previous embodiments, the wick clamp can be further able, under remote control, to adjust the height of the wick in the combustion area.

Any of the previous embodiments can further include a wick igniting device configured to electrically initiate burning of the insect repellent fuel in the combustion area of the torch. In some of these embodiments the wick igniting device is operable under remote control. And in some of these embodiments the wick igniting device is integral with a wick clamp that is configured to fix a height of the wick in the combustion area when the wick clamp is closed, and to enable adjustment of the height of the wick in the combustion area when the wick clamp is open.

Any of the previous embodiments can further include a fuel valve configured to allow or prevent entry into the fuel insert of pressurized insect repellent fuel from the fuel delivery pipe.

Any of the previous embodiments can further include a local controller that is configured to control and/or monitor at least one feature of the conversion kit. In some of these embodiments the local controller is configured for wireless communication with a remote computing device.

Any of the previous embodiments can include the ability for at least one feature of the conversion kit to be controlled and/or monitored by software operating on a remote computing device via wireless communication.

Any of the previous embodiments can further include a battery configured to provide electrical operation power to at least one feature of the conversion kit. And in some of these embodiments the conversion kit further comprises a solar collection device that is configured to recharge the battery using solar power.

A second general aspect of the present invention is a method of converting an insect repellent torch for implementation of automatic refueling from a remote fuel source while fuel is being burned by the insect repellent torch, wherein the insect repellent torch includes a fuel tank configured to contain insect repellent fuel and a wick port through which a wick can extend from within the fuel tank into a combustion area above the insect repellent torch. The method includes providing an automatic refueling conversion kit according to claim 1, using the fuel delivery seal, sealing the proximal fuel opening of the fuel insert to the distal end of the fuel delivery pipe, and using the wick seal, sealing the distal wick opening of the fuel insert to a wick, thereby forming a fuel insert assembly, installing the fuel insert within the interior of the insect repellent torch, extending a distal end of the wick upward and out from the interior of the insect repellent torch through an upper opening provided in the insect repellent torch and into the combustion area of the insect repellent torch, and directing insect repellent fuel through the fuel delivery pipe and into the fuel insert.

In embodiments, the fuel insert is substantially rigid, and installing the fuel insert within the interior of the insect repellent torch includes removing a fuel tank from the insect repellent torch and installing the fuel insert in place of the fuel tank.

Any of the above embodiments can include the feature that the fuel insert can be compressed and re-expanded, and in these embodiments installing the fuel insert within the interior of the insect repellent torch can include providing or creating an insertion port in the insect repellent torch that provides access between the interior of the insect repellent torch and an exterior of the insect repellent torch, compressing the fuel insert, inserting the fuel insert through the insertion port and into the interior of the insect repellent torch, and re-expanding the fuel insert. In some of these embodiments creating the insertion port includes drilling a hole in the insect repellent torch in a region of the insect repellent torch that is substantially opposed to the wick port.

And any of the previous embodiments can further include connecting a proximal end of the fuel delivery pipe to a central fuel reservoir of an external torch refueling system.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A illustrates use in the prior art of torches that burn a fuel mixed with an insect repellent to exclude insect pests from an outdoor activity area, where the torches are self-contained and cannot be refilled with fuel while burning or while hot from recent use;

FIG. 1B is a cross-sectional view of a representative insect repelling torch of the prior art for which the shell of the torch functions as the fuel tank;

FIG. 1C is a cross-sectional view of another representative insect repelling torch of the prior art that includes a separate fuel tank within an outer shell;

FIG. 2A is a cross-sectional view of a fuel insert assembly in an embodiment of the present invention wherein the fuel insert is a flexible bladder;

FIG. 2B is a cross-sectional view of a fuel insert assembly in an embodiment of the present invention wherein the fuel insert is a substantially rigid;

FIG. 3 is a cross-sectional view of an insect repelling torch in which an insertion port has been provided, together with the fuel insert assembly of FIG. 2 positioned for insertion through the insertion port;

FIG. 4A is a cross-sectional view of the embodiment of FIG. 3, showing the fuel insert assembly inserted through the insertion port and the fuel insert inflated with torch fuel;

FIG. 4B is a cross-sectional view of an embodiment similar to FIG. 4A, but applied to the torch of FIG. 1C;

FIG. 4C is a cross-sectional view of an embodiment similar to FIG. 4B, but wherein the fuel insert is rigid and directly replaces the fuel tank of the torch;

FIG. 5A is a cross-sectional view of an embodiment of the present invention that includes a sensor, fuel valve, and local controller that receive wired power from a remote source;

FIG. 5B is a cross-sectional view of an embodiment similar to FIG. 5A, but including more features and powered by batteries and a solar cell;

FIG. 5C is a cross-sectional view of an embodiment similar to FIG. 4C, but including a wick clamp and wick igniting device; and

FIG. 6 is a top view of a wick clamp that is included in FIG. 5B.

### DETAILED DESCRIPTION

The present invention is an apparatus and method for reducing production costs and increasing the range of styles that are available for insect repellent torches that are compatible with refueling from a central reservoir while they continue to burn fuel. Embodiments are compatible for inclusion as part of the insect repellent torch system with automatic fuel replenishment that is disclosed by co-pending application Ser. No. 16/918,767, which is also by the present Applicant, and is included herein by reference in its entirety for all purposes.

The present invention is a conversion kit and method of use thereof that is applicable to a wide array of existing designs of insect repellent torches, either to convert a previously manufactured, conventional torch into a remotely refuellable torch as a retrofit, and/or for implementation by a manufacturer of conventional insect repellent torches so as to manufacture remotely refuellable torches with minimal changes to an existing parts inventory and existing manufacturing process, thereby maintaining an economy of scale for parts and assembly steps that are common to both the conventional and refuellable torches, and consequently reducing the manufacturing costs of the remotely refuellable torches.

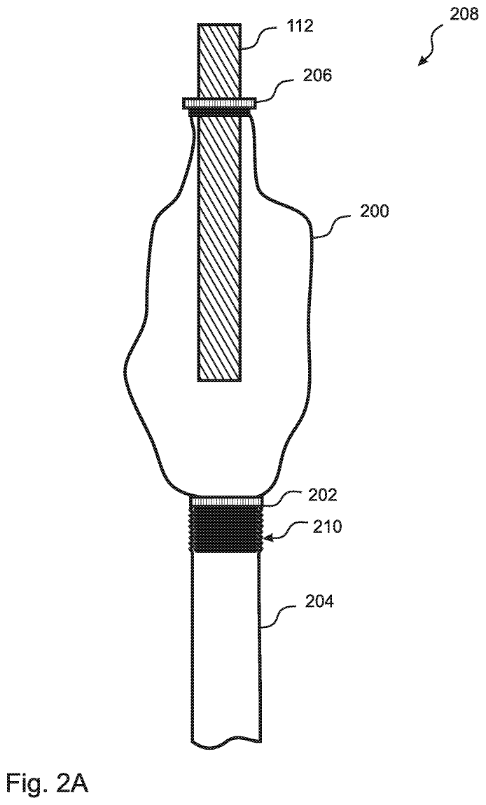

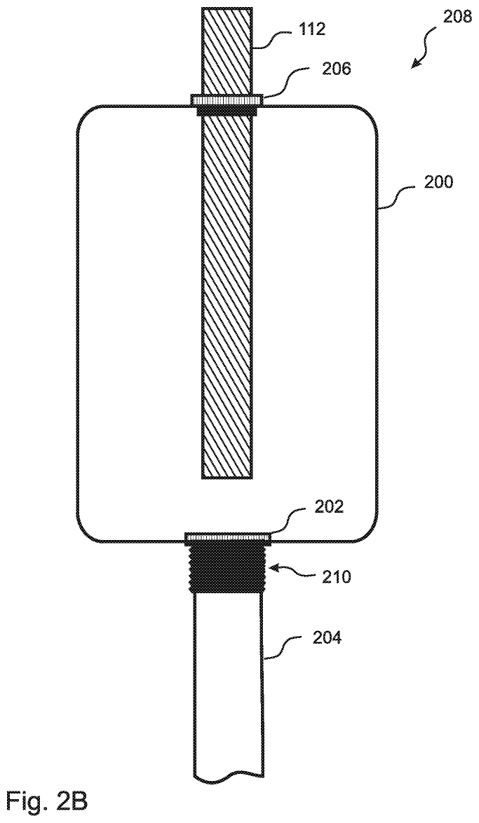

More specifically, with reference to FIGS. 2A and 2B, the disclosed conversion kit includes a fuel insert 200 that is configured to contain the insect repellent fuel 116. The fuel insert 200 is sealed or sealable by a fuel seal 202 at its proximal end to a fuel delivery pipe 204, and is sealed by a wick seal 206 at its distal end to a torch wick 112. In the illustrated embodiments the fuel delivery pipe 204 includes male threads 210 at its distal end. FIGS. 2A and 2B illustrate these components assembled together to form a “fuel insert assembly” 208. In the embodiment of FIG. 2A, the fuel insert is a flexible bladder, while in the embodiment of FIG. 2B the fuel insert is substantially rigid.

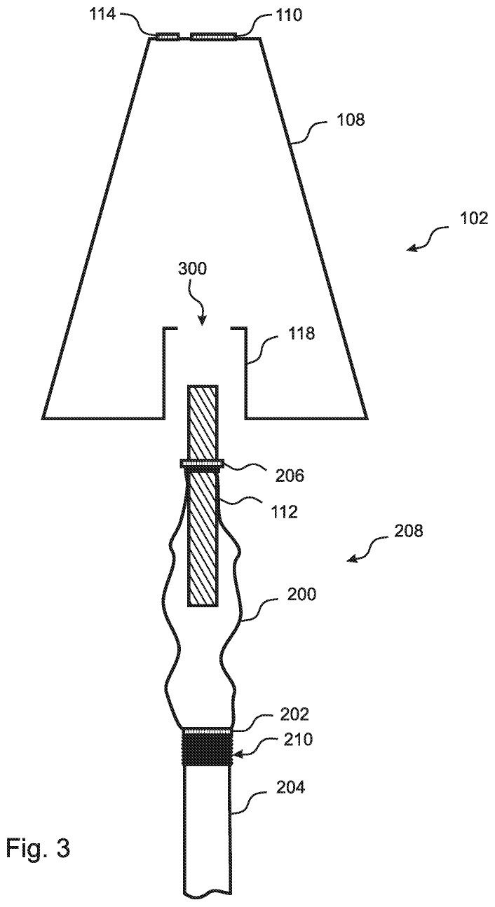

With reference to FIG. 3, in embodiments the method of the present invention includes creating or providing an insertion port 300 that provides access into the interior of the fuel tank 108 of a conventional insect repellent torch 102, and can be sealed to a fuel delivery pipe 204. In the embodiment of FIG. 3, the fuel insert 200 is a flexible bladder, and the insertion port 300 is created by drilling and tapping a hole 300 at the top of the cylindrical cavity 118 into which a pole 106 is normally inserted.

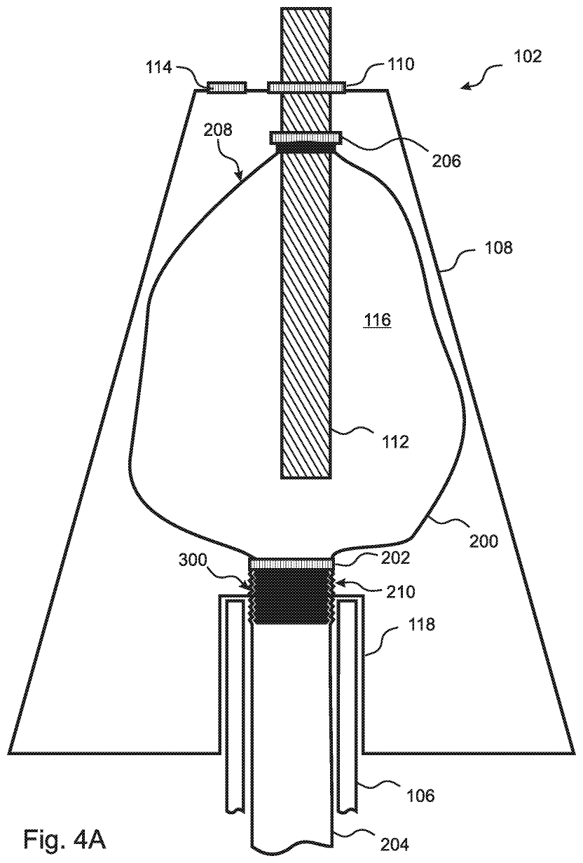

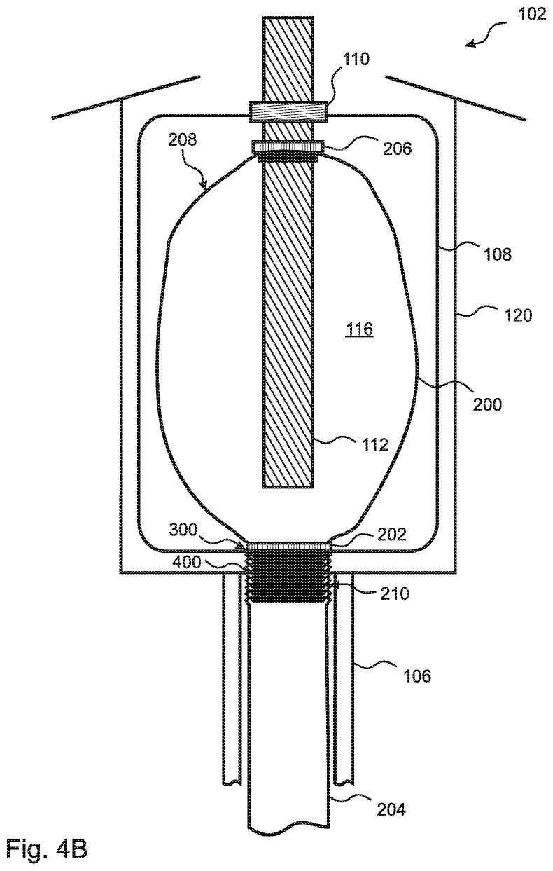

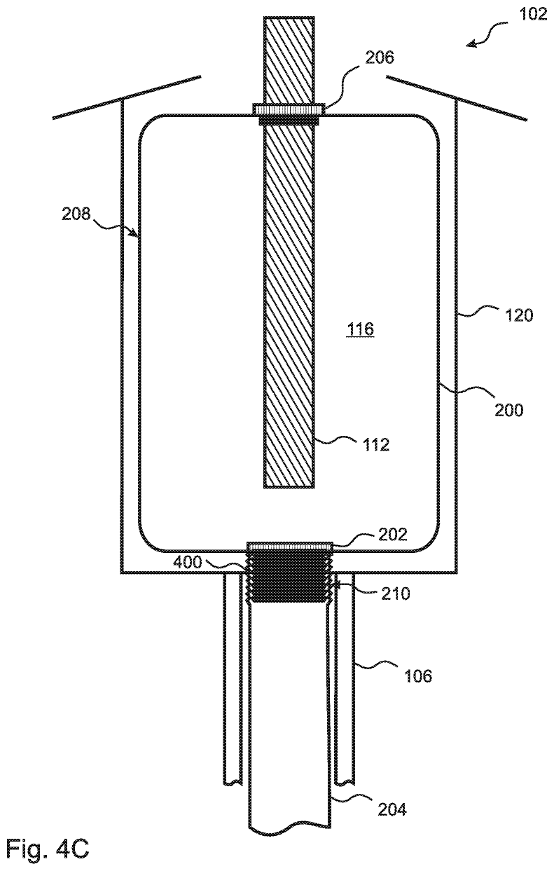

The method embodiment of FIG. 3 further includes inserting the fuel insert assembly 208 through the insertion port 300 and into the interior of the fuel tank 108. FIG. 3 illustrates the fuel insert assembly 208 positioned and ready for insertion through the insertion port 300, while FIG. 4A shows the same fuel insert assembly 208 after insertion into the fuel tank 108. It can be seen in FIG. 4A that, after insertion of the fuel insert assembly 208 through the insertion port 300, the wick 112 extends upward through the wick port 110 and above the fuel tank 108 into the combustion area, while the fuel delivery pipe 204 extends from the fuel insert 200 downward and out of the fuel tank 108 through the insertion port 300.

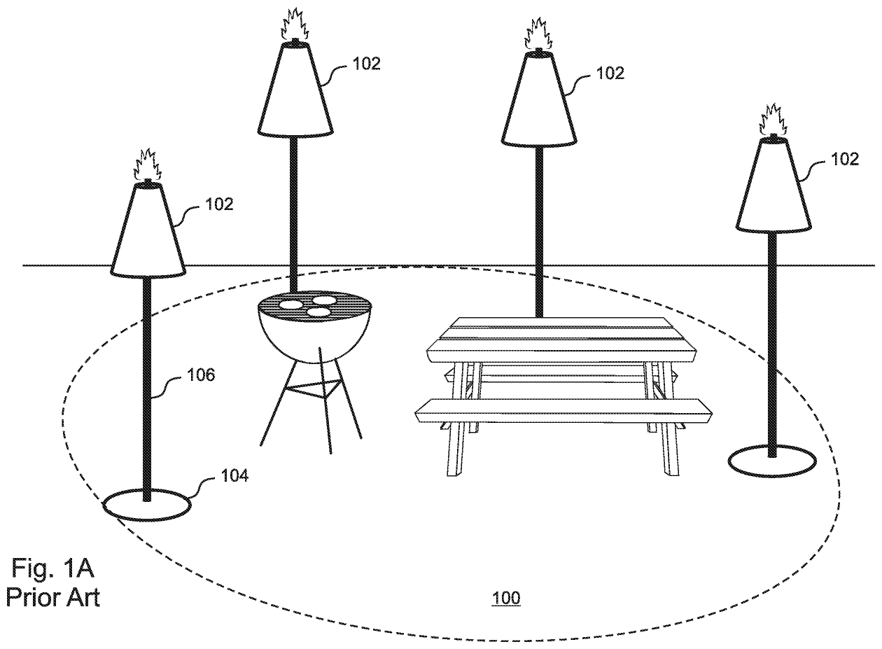

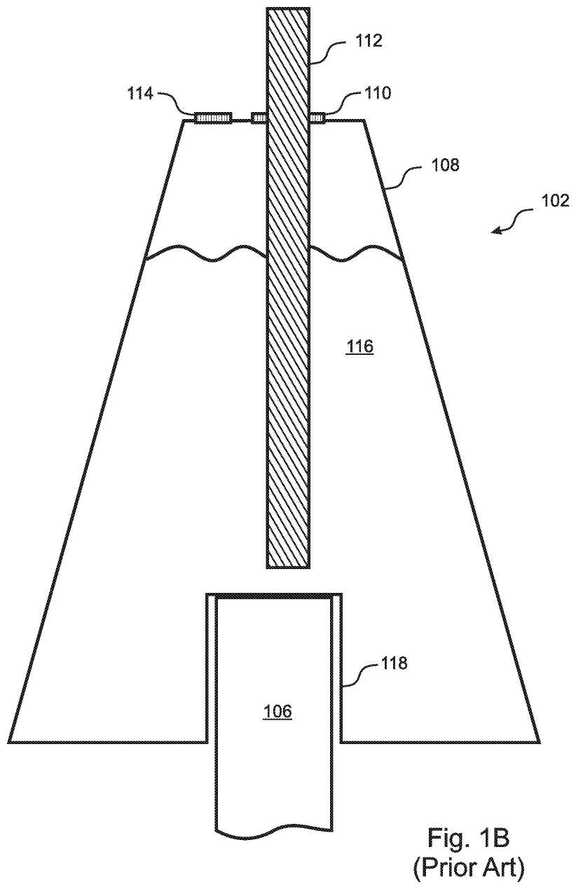

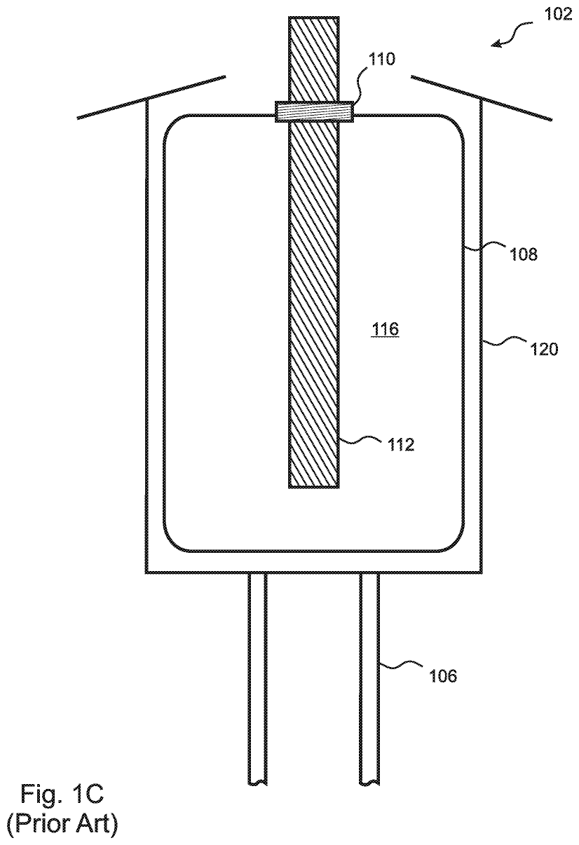

FIG. 4B illustrates an embodiment similar to FIG. 4A but applied to the torch 102 of FIG. 1C, wherein the conventional fuel tank 108 is a separate inner fuel canister that is surrounded by an outer shell 120. In this embodiment, the fuel insert 200 is a flexible bladder, and the torch 102 is further modified by providing an access hole 400 through the outer shell 120 through which the fuel delivery pipe 204 can pass so as to be sealed to the insertion port 300 of the fuel tank 108.

In some embodiments the fuel insert 200 is made from, or includes, a resilient material or structure such as a resilient plastic that can be temporarily compressed for insertion through the insertion port 300, after which it returns to an uncompressed state, and thereby increases the fuel volume of the fuel insert 200 once it is inside of the fuel tank 108 of the torch 102. In the embodiments of FIGS. 3, 4A, and 4B, the fuel insert 200 is a bladder that is made of a flexible material, such as a polymer film, which may be an elastomeric film, and is illustrated as having been inflated as it was filled by torch fuel 116 delivered to the fuel insert 200 within the fuel tank 108 via the fuel delivery pipe 204.

FIG. 4C illustrates an embodiment similar to FIG. 4B, but wherein the fuel insert 200 is a substantially rigid canister that directly replaces the conventional fuel tank 108 of the torch, which is removed from the torch 102.

In the embodiments of FIGS. 4A-4C the fuel delivery pipe 206 extends downward from the torch 102 through the center of a hollow pole 106, which for example could be a length of PVC pipe or another conventional pipe. In the illustrated embodiments, the fuel delivery pipe 206 is fixed to the torch 102 by male threads 210 at its distal end, which engage with female threads tapped in the insertion port 300 (FIGS. 3 and 4A) and/or the access hole 400 provided in the outer shell 120 (FIGS. 4B and 4C). In other embodiments, a quick-connect, O-ring, collar magnet, split ring clamp, or other attachment is used to fix the fuel insert assembly 208 to the torch 102. It is notable that in embodiments the attachment of the fuel delivery pipe 206 to the torch, or other attachment of the fuel insert assembly 208 to the torch 102, need only be mechanically competent. It is not necessary that the insertion port 300 or access hole 400 be sealed, because the torch fuel 116 is fully contained by the fuel insert 200. It is also not necessary in embodiments that the fuel insert 200 be structurally competent, nor is it necessary for the fuel insert 200 to meet fire safety requirements and/or other regulatory requirements, because these requirements are met by the torch fuel tank 108 or other torch elements that surround the fuel insert 200.

It is notable that in the embodiment of FIG. 4A, the fuel filling port 114 remains present, but is no longer used. In some embodiments where the disclosed conversion kit is applied during manufacture of a new torch, the manufacturing step of creating the fuel filling port 114 is omitted, and the fuel filling port 114 is not included in the converted torch 102. In the embodiments of FIGS. 4B and 4C, before the torch 102 is modified according to the present invention, the fuel tank 108 is filed by temporarily removing the wick 112 and filling the fuel tank 108 through the wick port 110. These embodiments therefore do not include a separate fuel filling port 114.

It should also be noted that conversion of the torch 102 to remote refueling while in use eliminates any need to maintain a large quantity of fuel 116 locally within the torch 102. Instead, embodiments of the present invention significantly reduce the amount of fuel 116 that is maintained within the torch 102 by limiting the size of the fuel insert 200, thereby reducing evaporative waste of fuel 116 between usages of the torch 102, and reducing dangers associated with tipping of the torch 102 and spilling of fuel 116.

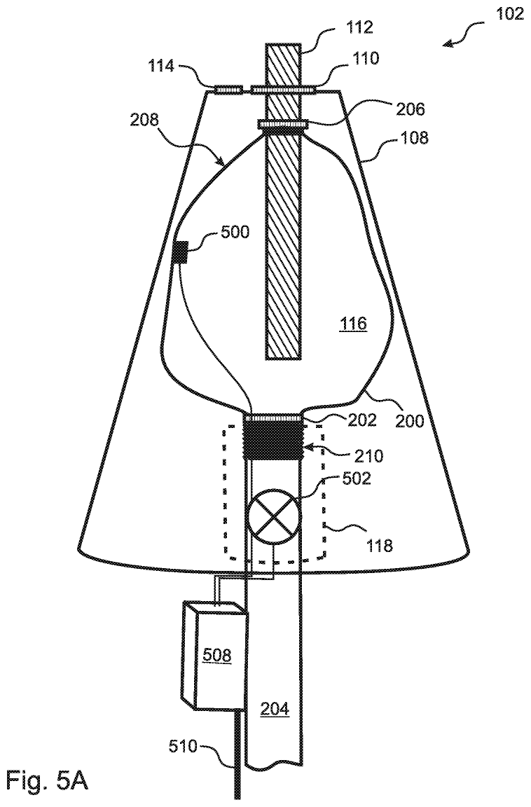

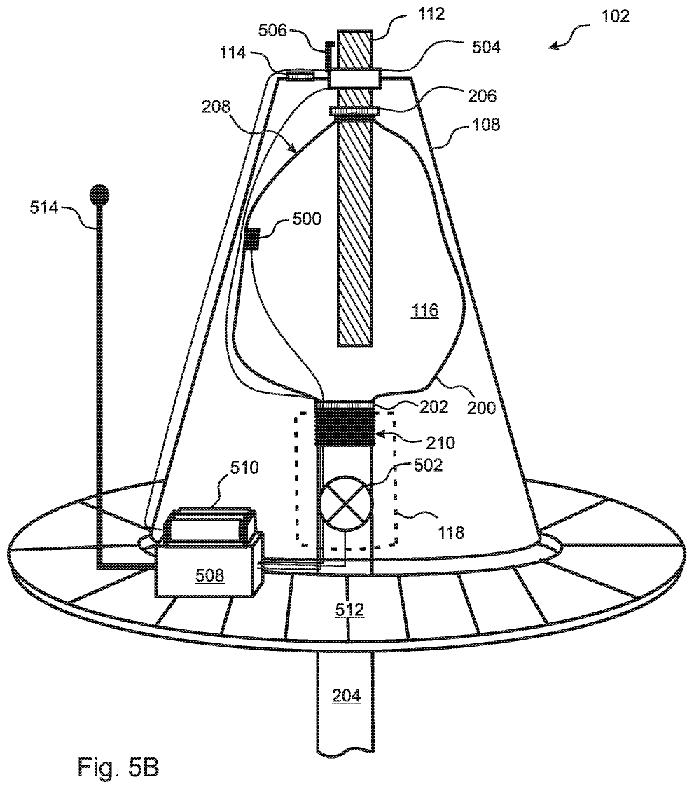

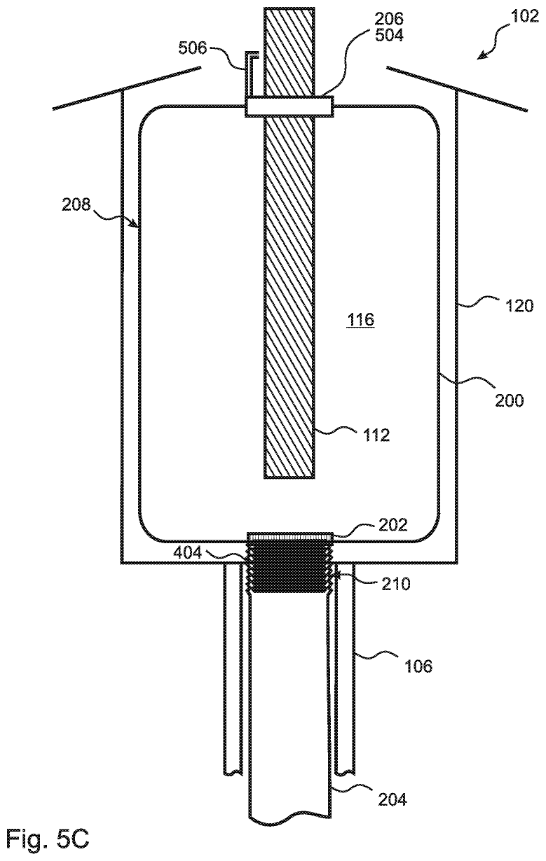

With reference to FIG. 5A, in embodiments the fuel insert assembly 208 further includes at least one sensor 500 that can be used to determine a quantity of fuel 116 that is contained within the fuel insert 200. The at least one sensor 500 can include a fuel level sensor and/or a pressure sensor. For example, if the fuel insert 200 is a bladder that is made from an expandable, elastic material, then a measurement of the internal pressure of the fuel 116 within the fuel insert 200 can be an indication of the degree to which the fuel insert 200 has been expanded by the fuel 116, and hence an indication of the quantity of fuel 116 that is contained within the fuel insert 200.

The conversion kit embodiment of FIG. 5A further includes a fuel valve 502 that is configured to allow or prevent entry into the fuel insert 200 of pressurized fuel 116 from the fuel delivery pipe 204. The sensor 500 and the fuel valve 502 are controlled by a local controller 508 that receives electrical power from an external source via a power line 510 that is directed to the torch 102 in parallel with the fuel delivery pipe 204.

FIG. 5B illustrates an embodiment that is similar to FIG. 5A, but further includes a remotely controlled wick clamp 504 that is configured to transition under remote control between clamping the wick 112 in place relative to the top of the torch 102 and allowing the wick 112 and attached fuel insert 200 to be raised and lowered relative to the top of the torch 102, for example to adjust the burning rate of the fuel 116. In various embodiments, the wick clamp 504 further includes a wick advancing mechanism that can raise and lower the wick 112 relative to the top of the torch 102 under remote control.

In addition, the embodiment of FIG. 5B further includes a wick igniting device 506 that is integral with the wick clamp 504. In other embodiments the wick clamp 504 and wick igniting device 506 are separate. In the embodiment of FIG. 5B, the sensor 500, fuel valve 502, wick clamp 504, and wick igniting device 506 are controlled by a local controller 508 that is powered by batteries 510, where the batteries are recharged by a solar panel 512. The local controller 508 is in wireless communication via an antenna 514 with a remote computing device (not shown, see application Ser. No. 16/928,767 included herein by reference).

FIG. 5C illustrates an embodiment that is similar to FIG. 4C, but which includes the remotely controlled wick clamp 504 and wick igniting device 506 of FIG. 5B. In the illustrated embodiment, the fuel insert 200 is substantially rigid, and the wick clamp 504 also functions as the wick seal 206, as well as transitioning under remote control between clamping the wick 112 in place relative to the top of the fuel insert 200 and allowing the wick 112 and attached fuel insert 200 to be raised and lowered into and out of the fuel insert 200.

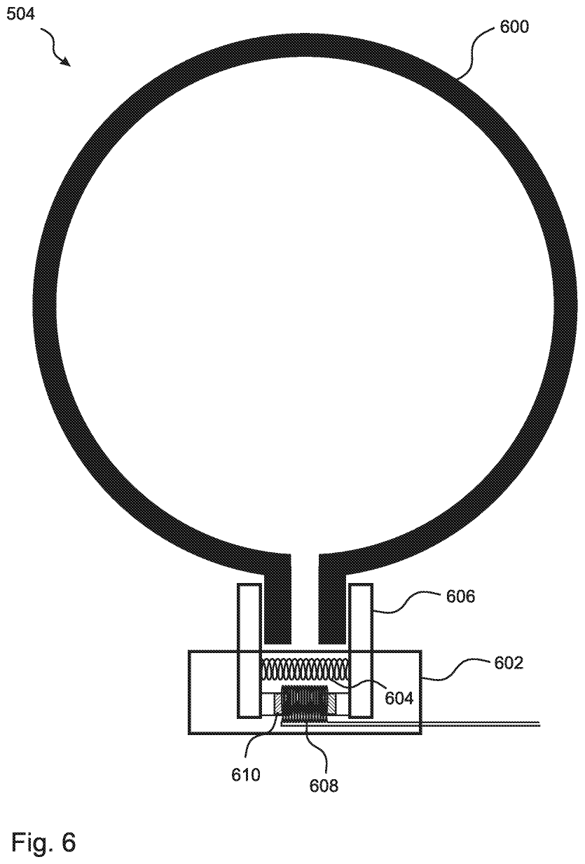

FIG. 6 illustrates details of the wick clamp 504 that is included in the embodiments of FIGS. 5B and 5C. In the embodiment of FIG. 6, the wick clamp 504 is a split-ring clamp 600 that can be opened by a remotely controlled clamping mechanism 602. In the illustrated embodiment, the split ring clamp 600 of the wick clamp 504 is normally held in a clamped configuration by a tension spring 604 acting on a pair of clamping arms 606. However, when adjustment of the position of the wick 112 relative to the top of the torch 102 is desired, or for any other reason, the split ring clamp 600 can be temporarily released by passing electrical current through a coil 608, thereby attracting together a pair of ferromagnetic blocks 610 that are also cooperative with the clamping arms 606, and overcoming the tension applied by the spring 604.

Instead of, or in addition to, implementing a level and/or pressure sensor, embodiments control the rate of fuel replenishment of the fuel insert 116 according to an estimated rate of fuel consumption, based on a known height of the wick 112 above the top of the torch 102. For example, in the embodiment of FIG. 5B the height of the wick 112 above the top of the torch 102 is adjusted by the wick clamp 504 under remote control by the local controller 508, according to commands received wirelessly from a remote controller such as a smart phone. In embodiments, the local controller 508 (and/or the remote controller) thereby is aware of the height of the wick 112 at all times, and can take any changes in wick height into account when estimating the remaining fuel based on cumulative fuel consumption since the last refill. In other embodiments where the wick height and the rate of fuel consumption is constant, the fuel can be refilled in fixed quantities and at pre-determined intervals, for example according to a preset timer.

It will be noted that some of the elements that are included in various embodiments of the disclosed conversion kit are not installed within the fuel tank 108. For example, in FIG. 5B the wick igniting device 506 is located external to the torch 102, proximal to the wick 112 as it extends through the wick port 110 above the torch 102. Similarly, the local controller 508, batteries 510 and solar panel 512 are all external to the torch 102 in the illustrated embodiment. Also, in the embodiments of FIGS. 5A and 5B the fuel valve 504 is within the cylindrical cavity 118 of the torch 102, and is not installed within the interior of the torch 102. Nevertheless, all of these features are in signal communication with the local controller 508 in the embodiment of FIGS. 5A and 5B, and all are included as part of the conversion kit in the illustrated embodiments.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the invention is not limited to just these forms, but is amenable to various changes and modifications without departing from the spirit thereof. The disclosure presented herein does not explicitly disclose all possible combinations of features that fall within the scope of the invention. The features disclosed herein for the various embodiments can generally be interchanged and combined into any combinations that are not self-contradictory without departing from the scope of the invention. In particular, the limitations presented in dependent claims below can be combined with their corresponding independent claims in any number and in any order without departing from the scope of this disclosure, unless the dependent claims are logically incompatible with each other.

1. An automatic refueling conversion kit applicable to an insect repellent torch, wherein the insect repellent torch includes a fuel tank configured to contain an insect repellent fuel and a wick port through which a wick can extend from within the fuel tank to a combustion area above the insect repellent torch, the conversion kit comprising:
a fuel insert configured to contain the insect repellent fuel within an interior of the insect repellent torch;
a fuel delivery pipe;
a fuel delivery seal configured to seal a proximal fuel opening of the fuel insert to a distal end of the fuel delivery pipe; and
a wick seal configured to seal a distal wick opening of the fuel insert to a wick;
wherein the wick is configured to extend upward and out from the interior of the insect repellent torch through an upper opening provided in the insect repellent torch.

2. The conversion kit of claim 1, wherein the fuel insert includes a resilient material and/or construction that can be compressed for insertion through an insertion port provided in the insect repellent torch and will afterward re-expand within the interior of the insect repellent torch.

3. The conversion kit of claim 1, wherein the fuel insert includes an elastic material that is configured to expand when the fuel insert is filled with insect repellent fuel.

4. The conversion kit of claim 1, wherein the fuel insert is formed by a substantially rigid material.

5. The conversion kit of claim 4, wherein the fuel insert is configured to replace a removable fuel canister of the insect repellent torch.

6. The conversion kit of claim 1, further comprising a sensor configured to provide a measurement that enables determining of a quantity of the insect repellent fuel that is contained within the fuel insert.

7. The conversion kit of claim 1, further comprising a remotely controllable wick clamp that is configured to fix a height of the wick relative to the combustion area when the wick clamp is closed, and to enable adjustment of the height of the wick relative to the combustion area when the wick clamp is open.

8. The conversion kit of claim 7, wherein the wick clamp is further able, under remote control, to adjust the height of the wick relative to the combustion area.

9. The conversion kit of claim 1, further comprising a wick igniting device configured to electrically initiate burning of the insect repellent fuel in the combustion area of the torch.

10. The conversion kit of claim 9, wherein the wick igniting device is operable under remote control.

11. The conversion kit of claim 10, wherein the wick igniting device is integral with a wick clamp that is configured to fix a height of the wick relative to the combustion area when the wick clamp is closed, and to enable adjustment of the height of the wick relative to the combustion area when the wick clamp is open.

12. The conversion kit of claim 1, further comprising a fuel valve configured to allow or prevent entry into the fuel insert of pressurized insect repellent fuel from the fuel delivery pipe.

13. The conversion kit of claim 1, further comprising a local controller that is configured to control and/or monitor at least one feature of the conversion kit.

14. The system of claim 13, wherein the local controller is configured for wireless communication with a remote computing device.

15. The conversion kit of claim 1, wherein at least one feature of the conversion kit can be controlled and/or monitored by software operating on a remote computing device via wireless communication.

16. The conversion kit of claim 1, further comprising a battery configured to provide electrical operation power to at least one feature of the conversion kit.

17. The system of claim 16, wherein the conversion kit further comprises a solar collection device that is configured to recharge the battery using solar power.

18. A method of converting an insect repellent torch for implementation of automatic refueling from a remote fuel source while fuel is being burned by the insect repellent torch, wherein the insect repellent torch includes a fuel tank configured to contain insect repellent fuel and a wick port through which a wick can extend from within the fuel tank into a combustion area above the insect repellent torch, the method comprising:
providing an automatic refueling conversion kit according to claim 1;
using the fuel delivery seal, sealing the proximal fuel opening of the fuel insert to the distal end of the fuel delivery pipe, and using the wick seal, sealing the distal wick opening of the fuel insert to a wick, thereby forming a fuel insert assembly;
installing the fuel insert within the interior of the insect repellent torch;
extending a distal end of the wick upward and out from the interior of the insect repellent torch through an upper opening provided in the insect repellent torch and into the combustion area of the insect repellent torch; and
directing insect repellent fuel through the fuel delivery pipe and into the fuel insert.

19. The method of claim 18, wherein the fuel insert is substantially rigid, and installing the fuel insert within the interior of the insect repellent torch includes removing a fuel tank from the insect repellent torch and installing the fuel insert in place of the fuel tank.

20. The method of claim 18, wherein the fuel insert can be compressed and re-expanded, and wherein installing the fuel insert within the interior of the insect repellent torch includes:
providing or creating an insertion port in the insect repellent torch that provides access between the interior of the insect repellent torch and an exterior of the insect repellent torch;
compressing the fuel insert;
inserting the fuel insert through the insertion port and into the interior of the insect repellent torch; and
re-expanding the fuel insert.

21. The method of claim 20, wherein creating the insertion port includes drilling a hole in the insect repellent torch in a region of the insect repellent torch that is substantially opposed to the wick port.

22. The method of claim 18, further comprising connecting a proximal end of the fuel delivery pipe to a central fuel reservoir of an external torch refueling system.
